(19) United States
(12) Patent Application Publication
(10) Pub. No.: US 2008/0304949 A1
(43) Pub. Date: Dec. 11, 2008

(54) METHOD AND APPARATUS FOR HANGING A GATE

(76) Inventors: Darren Lee Rudd, Ardmore, OK (US); John Kelly Davenport, Ardmore, OK (US)

Correspondence Address: DUKE W. YEE, YEE & ASSOCIATES, P.C., P.O. BOX 802333, DALLAS, TX, 75380, US

(21) Appl. No.: 11/759,584

(22) Filed: Jun. 7, 2007

(51) Int. Cl. B66F 19/00; E04B 1/00

(52) U.S. Cl. 414/744.1; 52/741.1

(57) ABSTRACT

An apparatus and method for hanging a gate is provided. The apparatus includes a first leg and a second leg. The second leg is coupled to the first leg such that the first leg forms an angle with the second leg. The apparatus also includes a link. The link is coupled to at least one of the first leg and the second leg. Also, the link is adapted to be coupled to a gate.

### BACKGROUND OF THE INVENTION

1. Technical Field

The illustrative embodiments described herein are directed generally toward devices and methods for hanging a gate.

2. Description of Related Art

Gates are adjoined to adjacent barriers using any of a large variety of methods. For example, a gate may be adjoined to a barrier by one or more hinges on either side of the gate. The one or more hinges allow the gate to swivel around an axis defined by the hinges.

Gates may also be fixedly attached to an adjacent barrier. For example, each end of a gate may be welded to an adjacent barrier such that the gate may not be moved relative to the barrier.

In order to properly affix a gate to an adjacent barrier, the gate should be properly aligned with the barrier. For example, affixing a swivel gate to an adjacent barrier via a set of hinges requires that the hinge connections on both the gate and adjacent barrier be properly aligned with one another. Improper alignment could result in the swivel gate failing to properly swivel around an axis relative to the hinges. Improper alignment may also result in the swivel gate having a crooked orientation relative to the ground or the adjacent barrier.

Welding, bolting, or otherwise affixing a gate to an adjacent barrier requires that the gate maintain a fixed position for an extended period of time. For example, a gate that is hinged to an adjacent gate must maintain a fixed position long enough for the hinge connection to be bolted or welded. Current methods of providing stability, such as by manually stabilizing the gate using one or more people are cumbersome and tiring.

Current methods of hanging a gate often require more than one person to hang the gate. Additional manual labor may be necessitated depending on the size, weight, or shape of the gate. For example, a single person often cannot properly align and stabilize a gate while simultaneously affixing the gate, such as by welding or bolting. Additional labor may increase the cost of affixing the gate.

Current methods of hanging a gate can also require unnecessary time. For example, properly aligning and stabilizing a gate using one or more people can require large amounts of time due to factors such as human error.

### SUMMARY OF THE INVENTION

An apparatus and method for hanging a gate is provided. The apparatus includes a first leg and a second leg. The second leg is coupled to the first leg such that the first leg forms an angle with the second leg. The apparatus also includes a link. The link is coupled to at least one of the first leg and the second leg. Also, the link is adapted to be coupled to the gate.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows an apparatus for hanging a gate in accordance with an illustrative embodiment.

FIG. 2 shows an intermediate connector assembly of an apparatus for hanging a gate in accordance with an illustrative embodiment.

FIG. 3 shows two apparatuses being used to hang a gate in accordance with an illustrative embodiment.

FIG. 4 shows the foot of an apparatus for hanging a gate in accordance with an illustrative embodiment.

FIG. 5 shows an apparatus for hanging a gate in accordance with an illustrative embodiment.

FIG. 6 shows an apparatus for hanging a gate in accordance with an illustrative embodiment.

FIG. 7 is a flowchart showing a method for hanging a gate in accordance with an illustrative embodiment.

### DETAILED DESCRIPTION

The illustrative embodiments described herein are directed toward an apparatus and method for hanging a gate. The apparatus includes a first leg and a second leg. The second leg is coupled to the first leg such that the first leg forms an angle with the second leg. As used herein, the term “coupled” includes coupling via a separate object. For example, a first leg can be coupled to a second leg if both the first leg and the second leg are coupled to a third object. The term “coupled” also includes “directly coupled,” in which case the two objects touch each other in some way. The apparatus also includes a link. The link is coupled to at least one of the first leg and the second leg. Also, the link is adapted to be coupled to the gate.

In an alternative embodiment, the link is coupled to the first leg and the second leg by an intermediate connector. Also, the first leg is coupled to the second leg by the intermediate connector. In another alternative embodiment, the link, the first leg, and the second leg are each pivotably attached to the intermediate connector.

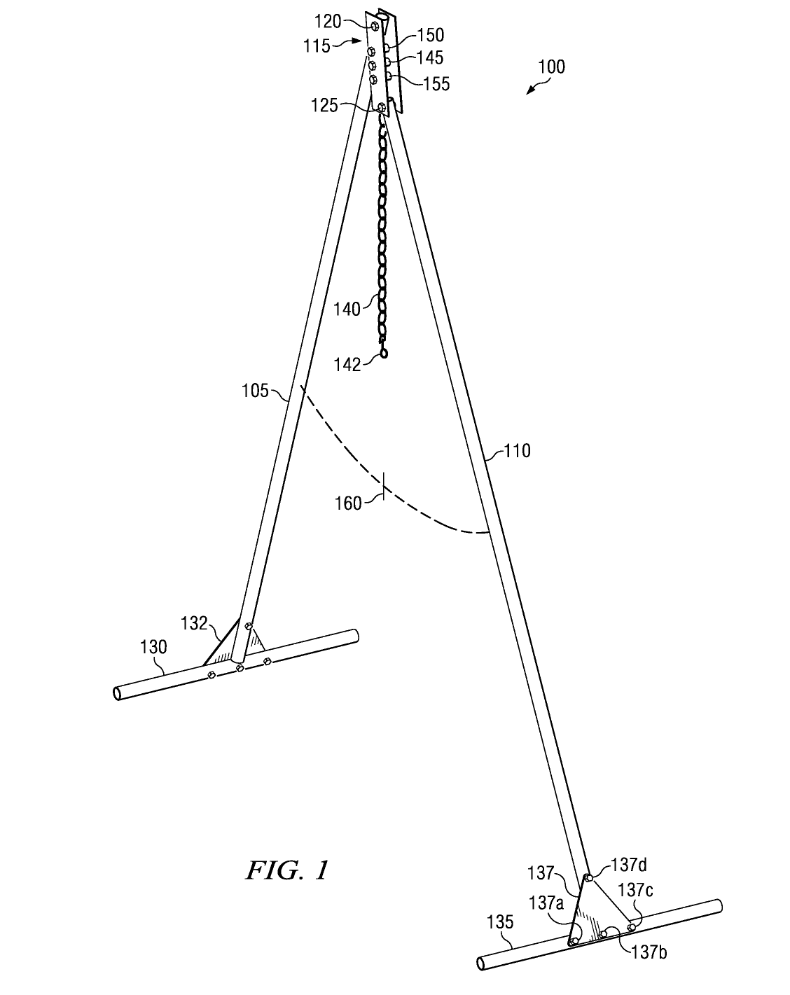

FIG. 1 depicts an apparatus for hanging a gate in accordance with an illustrative embodiment. In particular, FIG. 1 shows gate hanger 100 having two legs 105 and 110. Leg 105 is coupled to the leg 110 by intermediate connector 115. Legs 105 and 110 are connected to intermediate connector 115 by leg hinges 120 and 125. Specifically, leg 105 is connected to intermediate connector 115 by leg hinge 125. Leg 110 is connected to intermediate connector 115 by leg hinge 120.

Legs 105 and 110 are depicted as lying in the same plane. Legs 105 and 110 may also lie in about the same plane. Legs 105 and 110 lie in about the same plane if the deviation of either leg 105 or 110 from a common plane does not affect the operation of gate hanger 100.

Legs 105 and 110 form angle 160. Angle 160 may be any desired angle equal to or greater than 0° that facilitates the operation of gate hanger 100, such as, but not limited to 30°, 45°, 90°, 120°, or 160°. Angle 160 is dependent upon the particular application of gate hanger 100 and whether gate hanger 100 is being used, stored, or transported.

Although FIG. 1 depicts legs 105 and 110 as having a circular cross-section, the cross-section of legs 105 and 110 may be any shape. For example, the cross-section of legs 105 and 110 may be a rectangle or polygon, such as a triangle, square, pentagon, or hexagon. Legs 105 and 110 may also have an elliptical, complex, or irregular cross-section.

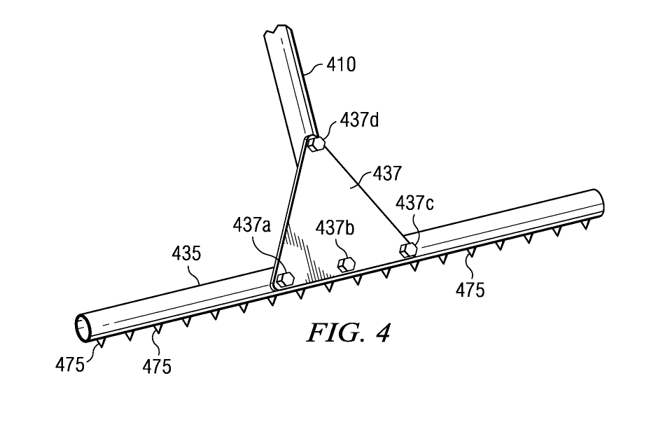

Legs 105 and 110 are coupled to feet 130 and 135. Specifically, leg 105 is coupled to foot 130 by attachment plate 132. Leg 110 is coupled to foot 135 by attachment plate 137. Attachment plate 137 is affixed to leg 110 by plate connector 137d. Attachment plate 137 is affixed to foot 135 by plate connectors 137a, 137b, and 137c. The foot assembly is discussed in greater detail with respect to FIG. 4.

Link 140 is coupled to legs 105 and 110 by intermediate connector 115. Link 140 is attached to intermediate connector 115 by link hinge 145. The hanging end of link 140 is attached to fastener 142. Fastener 142 is provided so that link 140 can be coupled to a gate.

Although FIG. 1 depicts link 140 as a chain, link 140 may be any link that is adapted to be coupled to a gate. For example, link 140 may be a rigid or flexible strap, a string, a pole, a tie, or a latch, any of which having a corresponding structure for attachment to a gate. In addition, link 140 may be composed of any of a number of materials, including leather, rubber, metal, cloth, plastic, wood, or any other material suited to linking intermediate connector 115 to a gate.

Legs 105 and 110 and feet 130 and 135 may also be composed of any of a number of materials. For example, legs 105 and 110 and feet 130 and 135 may be composed of different types of metal, such as galvanized metal, steel, aluminum, or copper. In addition, legs 105 and 110 and feet 130 and 135 may be composed of plastic, polyvinyl chloride (PVC), wood, and or other rigid material. Legs 105 and 110 and feet 130 and 135 may each be composed of different materials, such as those listed above.

Intermediate connector 115 also includes leg rests 150 and 155, which are each located on an opposite side of link hinge 145. Leg rest 150 hinders the movement of leg 110. Specifically, leg rest 150 hinders leg 110 from swiveling in a direction toward link 140. Leg rest 150 prevents gate hanger 100 from collapsing so that gate hanger 100 can stand up without outside aid. FIG. 1 depicts gate hanger 100 as standing without outside aid.

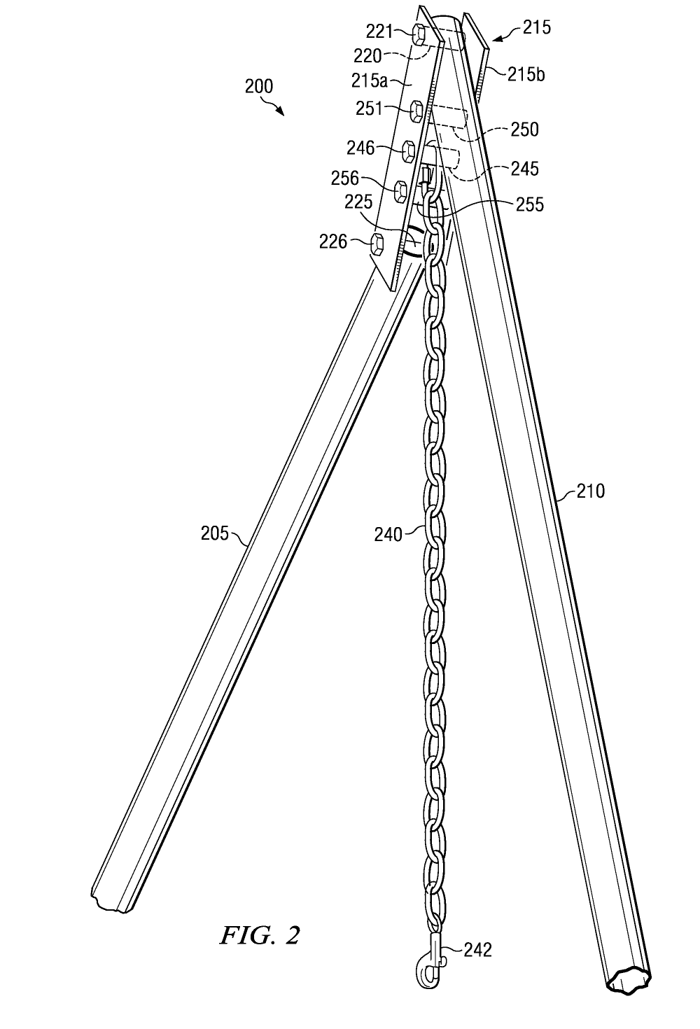

FIG. 2 shows an intermediate connector assembly of an apparatus for hanging a gate in accordance with an illustrative embodiment. A non-limiting example of the intermediate connector assembly shown in FIG. 2 is shown in FIG. 1 as intermediate connector 115 and the parts adjacent to intermediate connector 115.

Specifically, FIG. 2 depicts intermediate connector 215 as comprising a plurality of bars. Intermediate connector 215 includes intermediate connector bars 215a and 215b. Intermediate connector bars 215a and 215b may be composed of any of variety of materials, such as galvanized metal, steel, aluminum, or copper, plastic, wood, or PVC. Additionally, intermediate connector bars 215a and 215b may each have a flexible structure, such as a strap composed of leather, cloth, or rubber.

Although FIG. 2 depicts intermediate connector 215 as being composed of intermediate connector bars 215a and 215b, intermediate connector 215 may have any of a variety of structural configurations. For example, intermediate connector 215 may be a C-tube that is elongated such that legs 205 and 210 and link 240 may be coupled to intermediate connector 215. Intermediate connector 215 may also be a single continuous strap or tab that is composed of leather, cloth, rubber, plastic, wood, or PVC.

Legs 205 and 210 are pivotably attached to intermediate connector 215 by leg hinges 220 and 225, respectively. Thus, legs 205 and 210 are coupled to each other via intermediate connector 215. Leg hinges 220 and 225 are coupled to intermediate connector 215 by leg hinge bolts 221 and 226, respectively.

Although FIG. 2 depicts leg hinges 220 and 225 as bolted onto intermediate connector 215 by leg hinge bolts 221 and 226, leg hinges 220 and 225 may be coupled onto intermediate connector 215 in a variety of configurations. For example, leg hinges 220 and 225 may be welded or glued onto intermediate connector 215. Leg hinges 220 and 225 may also constitute a continuous structural portion of intermediate connector 215.

Leg 205 pivots about an axis defined by leg hinge 225. Leg 210 pivots about an axis defined by leg hinge 220. Although FIG. 2 depicts legs 205 and 210 as pivotably attached to intermediate connector 215, legs 205 and 210 may also be fixedly or slidably attached to intermediate connector 215. For example, legs 205 and 210 may be able to slide along an axis defined by leg hinges 220 and 225, respectively.

FIG. 2 also depicts link 240 pivotably attached to intermediate connector 215 by link hinge 245. Link hinge is coupled to intermediate connector 215 by link hinge bolt 246.

Although FIG. 2 depicts link hinge 245 as bolted onto intermediate connector 215 by link hinge bolt 246, link hinge 245 may be coupled onto intermediate connector 215 using a variety of means. For example, link hinge 245 may be welded or glued onto intermediate connector 215. Link hinge 245 may also constitute a continuous structural portion of intermediate connector 215.

Link 240 pivots about an axis defined by link hinge 245. Although FIG. 2 depicts link 240 as pivotably attached to intermediate connector 215, link 240 may also be fixedly or slidably attached to intermediate connector 215. For example, link 240 may slide along an axis defined by link hinge 245.

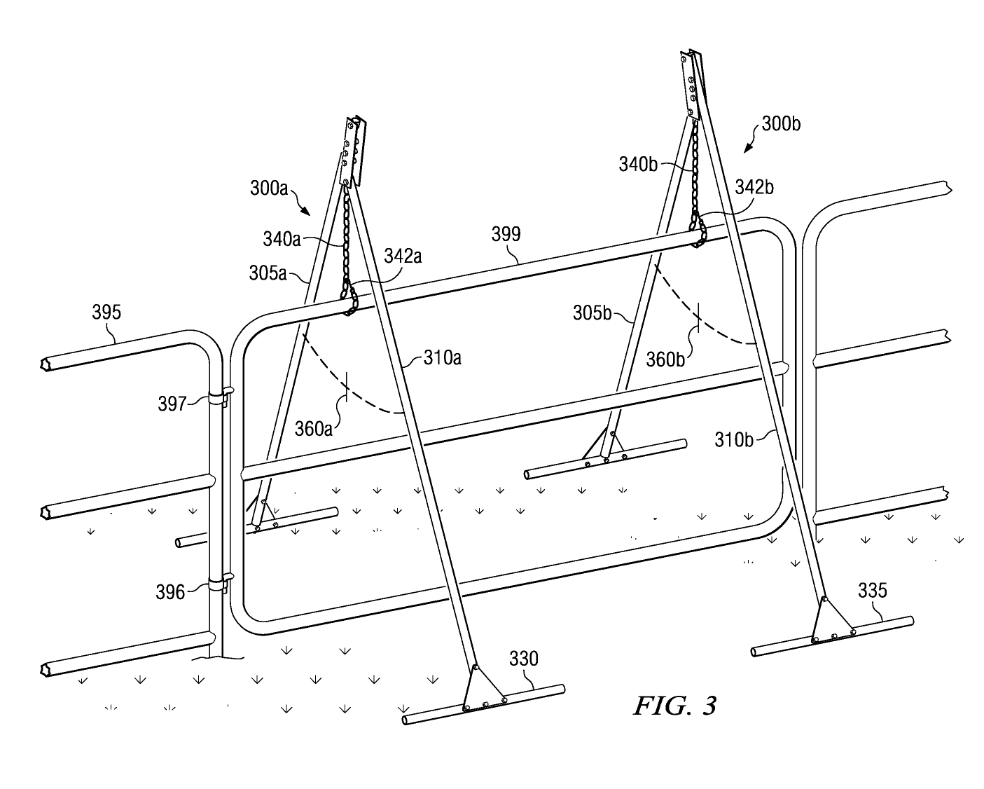

Fastener 242 is attached to link 240. Fastener 242 adapts link 240 to be coupled to a gate. Fastener 242 may fasten directly to a gate by clamping onto the gate. Fastener 242 may also be looped through a gate and fastened onto a portion of link 240. The latter configuration is discussed in greater detail with respect to FIG. 3.

Although FIG. 2 depicts fastener 242 as a clamp-like device, fastener 242 can have any structural configuration that adapts link 240 to be coupled to a gate. For example, fastener 242 may be a claw-like device that grips a gate. Fastener 242 may also be a suction device that uses suction to attach to a gate.

Intermediate connector 215 includes leg rests 250 and 255. Leg 210 rests upon leg rest 250 when gate hanger 200 is in a standing position, such as the position of gate hanger 100 in FIG. 1. Leg rests 250 and 255 are coupled to intermediate connector 215 by leg rest bolts 251 and 256, respectively.

Although FIG. 2 depicts leg rests 250 and 255 as bolted onto intermediate connector 215 by leg rest bolts 251 and 256, leg rests 250 and 255 may be coupled onto intermediate connector 215 using a variety of means. For example, leg rests 250 and 255 may be welded or glued onto intermediate connector 215. Leg rests 250 and 255 may also constitute a continuous structural portion of intermediate connector 215.

FIG. 3 shows two apparatuses being used to hang a gate in accordance with an illustrative embodiment. Specifically, FIG. 3 shows gate hangers 300a and 300b being used to hang gate 399. Gate hangers 300a and 300b are each similar to gate hanger 100 of FIG. 1.

Links 340a and 340b each loop around the top portion of gate 399. Fasteners 342a and 342b fasten onto a portion of links 340a and 340b, respectively, to sustain the position of gate 399.

Legs 305a and 310a form angle 360a. Legs 305b and 310b form angle 360b. Angles 360a and 360b may by any angle that enables gate hangers 300a and 300b, respectively, to sustain the position of gate 399. For example, angles 360a and 360b may be 30°, 60°, 90°, 120°, or other angles.

In an illustrative embodiment, gate hangers 300a and 300b sustain the position of gate 399 so that gate 399 can be easily and correctly hung onto adjacent gate 395 at hinges 396 and 397. For example, gate hangers 300a and 300b may be used in conjunction with a leveling device to position gate 399 to be level with a ground surface. Gate hangers 300a and 300b also stabilize gate 399 to allow for a user to affix gate 399 to adjacent gate 395, such as by welding or bolting.

A user can make adjustments to the position of gate 399 by moving one or more parts of gate hangers 300a and 300b. For example, if the side of gate 399 that is attached to gate hanger 300a is lower than desired, angle 360a may be decreased, resulting in an upward force being applied to the portion of gate 399 attached to gate hanger 300a. A force may also be applied to the portion of gate 399 attached to gate hanger 300a by fastening fastener 342a onto various portions of link 340a. Feet 330 and 335 may also be moved relative to a ground surface to achieve a desired position for gate 399. Upon adjusting the position of gate 399 to a desired position, gate 399 may be properly affixed to adjacent gate 395 at hinges 396 and 397.

Although FIG. 3 depicts two gate hangers 300a and 300b, any number of gate hangers may be used to hang gate 399. For example, a single gate hanger or three or more gate hangers may be used to hang gate 399.

FIG. 4 shows the foot of an apparatus for hanging a gate in accordance with an illustrative embodiment. The foot depicted in FIG. 4 may be implemented as foot 130 and foot 135 of FIG. 1, and well as foot 330 and foot 335 of FIG. 3.

Specifically, FIG. 4 depicts leg 410 coupled to foot 435 by attachment plate 437. Attachment plate 437 is affixed to leg 410 by plate connector 437d. Attachment plate 437 is affixed to foot 435 by plate connectors 437a, 437b, and 437c.

Although FIG. 4 depicts leg 410 coupled to foot 435 by attachment plate 437, leg 410 may be coupled to foot 435 in a variety of ways. For example, foot 435 may be welded or bolted directly onto the end of leg 410. Also, leg 410 and foot 435 may be part of the same structure.

FIG. 4 also depicts a set of traction members 475 for use on feet, such as feet 130 and 135 shown in FIG. 1. The set of traction members 475 includes one or more structures that hinder the movement of foot 435 relative to a surface, such as a ground surface. In FIG. 4, the set of traction members 475 is depicted as a plurality of teeth. Other examples of the set of traction members 475 include one or more spikes, one or more suction devices, one or more bumps, or one or more elongated ridges. The set of traction members 475 may also be a material that causes high friction, such as sandpaper or an adhesive surface.

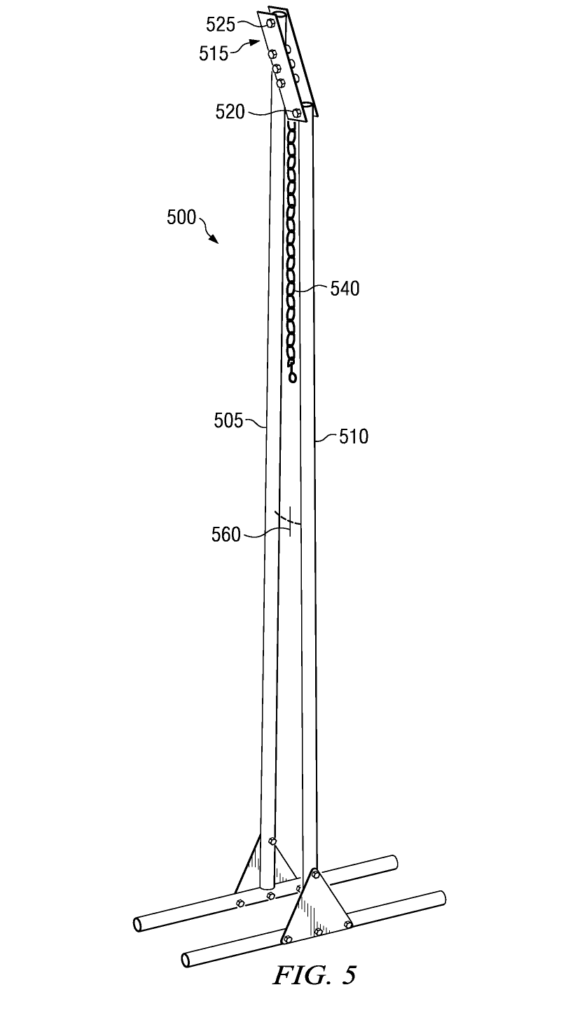

FIG. 5 shows an apparatus for hanging a gate in accordance with an illustrative embodiment. Specifically, FIG. 5 shows an example of the configuration of gate hanger 500 while gate hanger 500 is not being used to hang a gate or while gate hanger 500 is being stored or transported. For example, the configuration of gate hanger 500 may be implemented for gate hanger 100 of FIG. 1.

Legs 505 and 510 are pivoted such that legs 505 and 510 are substantially parallel to one another. As a result of the near-parallel position of legs 505 and 510, angle 560 is close to 0°. Angle 560 may also be close to 180° to achieve an alternative storage and transport configuration of gate hanger 500.

Legs 505 and 510 may be moved into a parallel position by pivoting legs 505 and 510 at leg hinges 520 and 525, located on intermediate connector 515. Link 540 is in a slack or rested position.

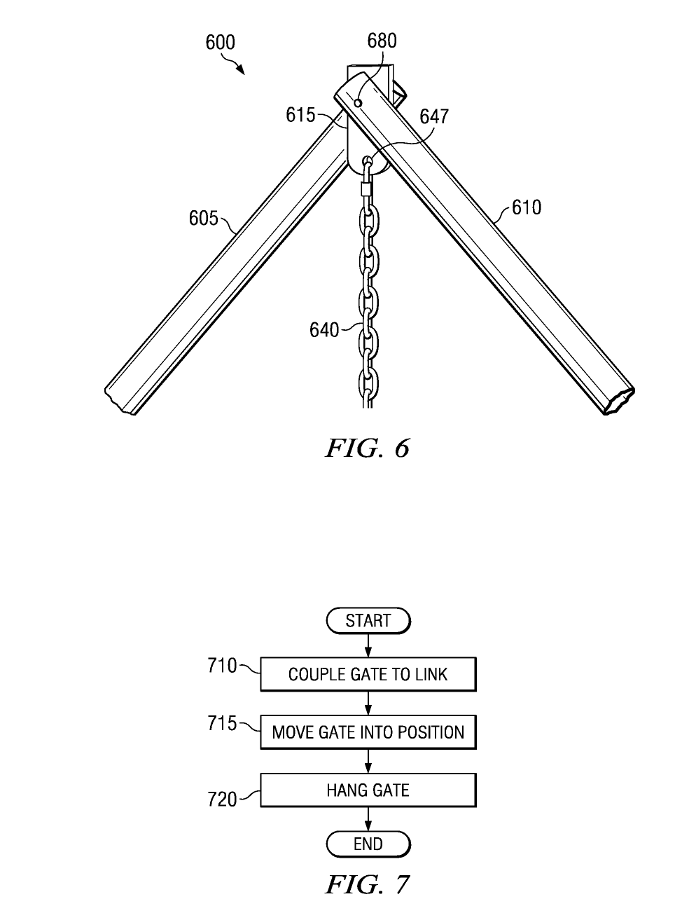

FIG. 6 shows an apparatus for hanging a gate in accordance with an illustrative embodiment. FIG. 6 shows an alternate intermediate connector assembly from the intermediate connector assembly shown in FIG. 2. Specifically, FIG. 6 shows gate hanger 600 in which leg 605 is coupled to leg 610 at leg joint 680. Leg joint 680 may be a bolt or rod structure that passes though legs 605 and 610 and intermediate connector 615. Intermediate connector 615 has a tab-like shape and is sandwiched between legs 605 and 610. Intermediate connector 615 may be composed of any material, including metal, wood, plastic, or PVC.

Link 640 is coupled to legs 605 and 610 by intermediate connector 615. Link 640 attaches to intermediate connector 615 at link hole 647, through which link 640 may pass. Link 640 may also be bolted or welded onto intermediate connector 615.

In an alternate embodiment, leg 605 may be coupled directly onto leg 610 by leg joint 680 without intermediate connector 615 being sandwiched between legs 605 and 610. In this embodiment, link 640 may be coupled to leg joint 680, leg 605, leg 610, or any combination thereof.

FIG. 7 is a flowchart showing a method for hanging a gate in accordance with an illustrative embodiment. The method can be implemented using a gate hanger, such as gate hanger 100 of FIG. 1. The process begins by coupling a gate to a link (step 710). For example, a gate, such as gate 399 of FIG. 3, that is lying flat on a ground surface may be coupled to the link. The link is coupled to at least one of a first leg and a second leg, such as legs 105 and 110 of FIG. 1. The second leg is coupled to the first leg such that the first leg forms an angle with the second leg.

Next, the gate is moved into a position (step 715). For example, the gate may be lifted from a flat position to an upright position. The position of the gate is sustained by the link.

Next, the gate is hung from the position (step 720). For example, the gate may be welded or bolted onto an adjacent gate, such as adjacent gate 395 of FIG. 3. The process then terminates.

The illustrative embodiments described herein are directed toward an apparatus and method for hanging a gate. The apparatus includes a first leg and a second leg. The second leg is coupled to the first leg such that the first leg forms an angle with the second leg. The apparatus also includes a link. The link is coupled to at least one of the first leg and the second leg. Also, the link is adapted to be coupled to the gate.

In an alternative embodiment, the link is coupled to the first leg and the second leg by an intermediate connector. Also, the first leg is coupled to the second leg by the intermediate connector. In another alternative embodiment, the link, the first leg, and the second leg are each pivotably attached to the intermediate connector.

The illustrative embodiments show an apparatus and method for hanging a gate that reduce the time and effort associated with hanging a gate. For example, a single person is able to hang a gate using the gate hangers in the illustrative embodiments, whereas hanging a gate would otherwise require multiple people. Because the amount of manual labor required for hanging a gate is reduced, the cost and human error associated with hanging a gate are also reduced. The gate hangers shown in the illustrative embodiments may also be easily transported, stored, and unassembled.

The description of the illustrative embodiments has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

What is claimed is:

1. An apparatus for hanging a gate, comprising:
a first leg;
a second leg, wherein the second leg is coupled to the first leg such that the first leg forms an angle with the second leg; and
a link, wherein the link is coupled to at least one of the first leg and the second leg, and wherein the link is adapted to be coupled to the gate.

2. The apparatus of claim 1, wherein the first leg and the second leg are in about a same plane.

3. The apparatus of claim 1, wherein the link is coupled to the first leg and the second leg by an intermediate connector.

4. The apparatus of claim 3, wherein the link is pivotably attached to the intermediate connector.

5. The apparatus of claim 3, wherein the first leg is coupled to the second leg by the intermediate connector.

6. The apparatus of claim 5, wherein the first leg is pivotably attached to the intermediate connector, and wherein the second leg is pivotably attached to the intermediate connector.

7. The apparatus of claim 3, wherein the intermediate connector comprises a plurality of bars.

8. The apparatus of claim 3, wherein the intermediate connector is a C tube.

9. The apparatus of claim 3, wherein the intermediate connector includes at least one leg rest.

10. The apparatus of claim 1, wherein the link is a chain.

11. The apparatus of claim 1, wherein the link is a flexible strap.

12. The apparatus of claim 1, further comprising:
a first foot, wherein the first foot is coupled to the first leg; and
a second foot, wherein the second foot is coupled to the second leg.

13. The apparatus of claim 12, wherein the first foot and the second foot are coupled to a set of traction members.

14. The apparatus of claim 1, wherein a cross-section of at least one of the first leg and the second leg is a circle.

15. The apparatus of claim 1, wherein the first leg and the second leg are comprised of galvanized metal.

16. A method for hanging a gate, the method comprising:
coupling the gate to a link, wherein the link is coupled to at least one of a first leg and a second leg, and wherein the second leg is coupled to the first leg such that the first leg forms an angle with the second leg;
moving the gate into a position, wherein the position of the gate is sustained by the link; and
hanging the gate from the position.

17. The method of claim 16, wherein the link is coupled to the first leg and the second leg by an intermediate connector.

18. The method of claim 17, wherein the first leg is coupled to the second leg by the intermediate connector.

19. The method of claim 18, wherein the first leg is pivotably attached to the intermediate connector, wherein the second leg is pivotably attached to the intermediate connector, and wherein the link is pivotably attached to the intermediate connector.

20. An apparatus for hanging a gate, comprising:
a first leg coupled to a first foot;
a second leg coupled to a second foot, wherein the second leg is coupled to the first leg such that the first leg forms an angle with the second leg; and
a link, wherein the link is adapted to be coupled to the gate, wherein the link is coupled to the first leg and the second leg by an intermediate connector, wherein the first leg is coupled to the second leg by the intermediate connector, wherein the first leg is pivotably attached to the intermediate connector, wherein the second leg is pivotably attached to the intermediate connector, wherein the link is pivotably attached to the intermediate connector, wherein the link is a chain, and wherein the first leg and the second leg are comprised of galvanized metal.
